(19) United States
(12) Patent Application Publication
(10) Pub. No.: US 2025/0367606 A1
(43) Pub. Date: Dec. 4, 2025

(54) FIELD FLOW FRACTIONATION CHANNEL ASSEMBLY SEALS

(71) Applicant: Wyatt Technology, LLC, Goleta, CA (US)

(72) Inventors: Anthony Clemens, Goleta, CA (US); Michael James Howo, Goleta, CA (US); Steven P. Trainoff, Santa Barbara, CA (US); David Rahmlow, Goleta, CA (US)

(21) Appl. No.: 19/224,063

(22) Filed: May 30, 2025

Related U.S. Application Data
(60) Provisional application No. 63/654,542, filed on May 31, 2024.

(51) Int. Cl. B01D 63/08; G01N 1/20

(52) U.S. Cl. CPC B01D 63/087; G01N 1/2035; B01D 2313/041

(57) ABSTRACT

A field flow fractionator comprises a top plate, a bottom plate, a channel between the top plate and the bottom plate, an o-ring between the top plate and the bottom plate to form a first seal for the channel, and a membrane along a bottom of the channel. The top plate further comprises a lip extending vertically from the top plate to form a second seal for the channel by directly abutting the membrane.

### RELATED APPLICATIONS

This application claims priority to U.S. provisional patent application No. 63/654,542 filed May 31, 2024 and titled “Field Flow Fractionation Channel Assembly Seals,” the contents of which are incorporated by reference in their entirety.

The present application is related to U.S. Patent Application Publication No. 2022/0134286, the contents of which are incorporated by reference in their entirety.

### FIELD

The present disclosure relates to field flow fractionators, and more specifically, to field flow fractionator channel assemblies.

### BACKGROUND

Asymmetric flow field flow fractionation (AF4) is a well-known technology where a sample is injected into a channel lined with a semi-permeable membrane. The membrane allows the carrier fluid to pass through, but not the particles (or molecules). The flow force through the membrane creates a flux that drives particles towards the membrane surface, but diffusion creates an opposite flux that counteracts the concentration that develops. The equilibrium balance of these two fluxes creates an exponential concentration profile that is maximal on the surface and decays with distance from the surface. Large particles experience a high downward force but have low diffusion coefficients, so the exponential decay length into the bulk is small. In contrast, small particles feel a small force towards the surface and have a high diffusion coefficient, so their exponential decay length is larger. When a flow is provided along the channel a velocity shear near the wall develops. The small particles which, on average, reside higher in the channel access streamlines with higher downstream velocity than the large particles. Therefore, the small particles move down the channel at a higher rate and elute first, followed by progressively larger fractions.

Conventional channel assemblies include a thin spacer that is sandwiched between a flat top plate and a membrane supported by a frit on the bottom plate. The membrane acts as a selective barrier, allowing solvent and salts to pass through while retaining larger analytes, which are fractionated by the FFF process described above. The whole assembly is bolted together to ensure that the membrane is compressed and that the spacer is pressed firmly against the top plate above and the bottom plate holding the membrane.

This sealing arrangement is intended to keep the sample and mobile phase within the channel volume between the top and bottom plates. However, imperfect seals between the spacers and plates can result in sample leakage and mass loss or other undesirable effects.

### SUMMARY

In one aspect, a field flow fractionator comprises a top plate; a bottom plate; a channel between the top plate and the bottom plate; an o-ring between the top plate and the bottom plate to form a first seal for the channel; and a membrane along a bottom of the channel, wherein the top plate further comprises a lip extending vertically from the top plate to form a second seal for the channel by directly by compressing the membrane.

In another aspect, a field flow fractionator comprises a top plate assembly formed of a material comprising a plurality of fluid fittings machined into the material; a membrane; a bottom plate assembly comprising a cavity machined into a top surface of the bottom plate assembly; a frit configured to be placed into the cavity, wherein the top plate assembly, the membrane, and the bottom assembly define a separation channel; and an o-ring between the top plate assembly and the bottom plate assembly to form a first seal for the separation channel. The top plate assembly further comprises a lip extending vertically from the top plate assembly to form a second seal for the channel by directly by compressing the membrane.

In another aspect, a field flow fractionator comprises a top plate comprising a cavity formed by first and second sidewalls extending 90 degrees from a top surface; a square or rectangular gasket constructed and arranged for positioning in the cavity, the gasket having a width that is the same as or similar to a width of the top surface and having a height greater than a height of the first and second sidewalls to be placed in the cavity for a line-to-line fit, wherein the width of the gasket and a width of cavity are the same, and wherein as pressurized, the gasket is forced against the first and second sidewalls; a membrane directly abutting a bottom surface of the gasket; a channel having an end at a side surface of the gasket; and a bottom plate that directly abuts the top plate to compress the gasket to form a first seal between the gasket and the cavity of the top plate and a second seal between the bottom surface of the gasket and the membrane.

### BRIEF DESCRIPTION OF THE DRAWINGS

FIG. 1A is an exploded view of a channel assembly of a field flow fractionator.

FIG. 1B is a cross-sectional view of the conventional asymmetric field flow fractionation (AF4) channel assembly of FIG. 1A.

FIG. 2 is a cross-sectional view of another conventional asymmetric field flow fractionation (AF4) channel assembly.

FIG. 3 is a cross-sectional view of an AF4 channel assembly, in accordance with preferred embodiments of the present inventive concept.

FIG. 4 is a cross-sectional view of an AF4 channel assembly, in accordance with other embodiments.

FIGS. 5-8 are illustrations of a computational fluid dynamics (CFD) simulation of an injection process in which embodiments of the present inventive concept can be practiced

FIG. 9 is a graph of a bovine serum albumin (BSA) mass recovery comparison between an ideal and non-ideal injection.

### DETAILED DESCRIPTION

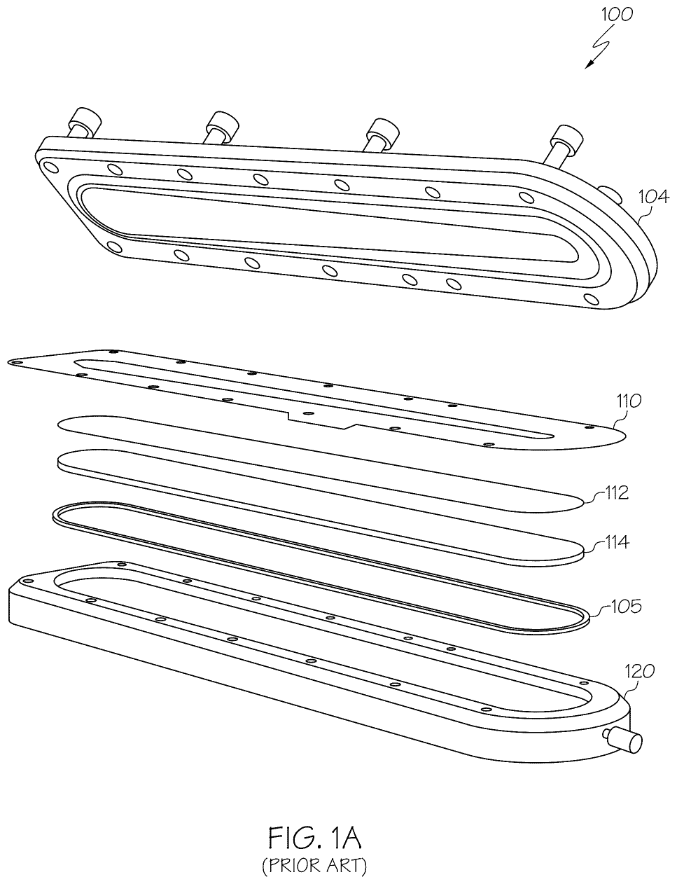

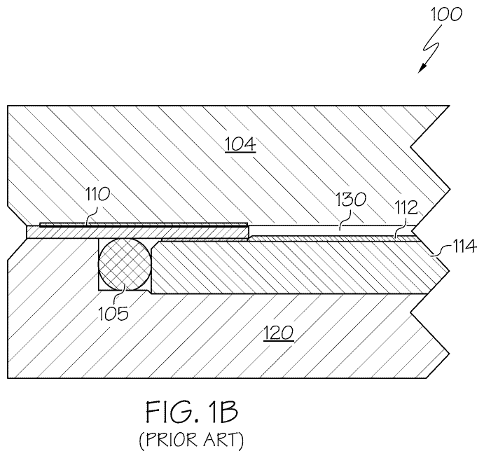

FIG. 1A is an exploded view of a channel assembly 100 of a field flow fractionator, in particular, a conventional AF4 channel assembly. FIG. 1B is a cross-sectional view of the AF4 channel assembly of FIG. 1A.

As shown, channel assembly may include a top plate 104, a spacer 110, a membrane 112, a frit 114, an o-ring 105, and a bottom plate 120, which form a channel 130. These components of the channel assembly 100 also form a sealing arrangement intended to keep the sample bearing fluid within the channel volume. The sample bearing fluid is distinguished from the mobile phase, or carrier fluid, which flows through the membrane 112 and permeates the frit 114.

The spacer 110 serves a number of roles, which require conflicting material properties. The spacer 110 sets the height of the separation channel 130 that controls, along with the analysis method, the fractionation size range, resolution, and sample dilution. By only changing the spacer 110, one can adjust the thickness and shape of the channel volume. The spacer 110 contributes to the seal by preventing fluid from escaping the channel 130 (except through the inlet and outlet ports). Typically, the AF4 channel assembly 100 is typically bolted together, i.e., using bolts extending through the top plate 104, also referred to as a top block, into the bottom plate 120, also referred to as a bottom block, bottom assembly, or base, and compressing the components therebetween, in particular to ensure that the o-ring 105 is compressed and that the spacer 110 is pressed firmly between the top plate 104 and the membrane 112 and frit 114.

The o-ring 105 seals the bottom assembly 120 to the bottom of the spacer 110, but the spacer 110 is typically formed of a hard plastic material such as polyethylene terephthalate (PET) or the like. This hard material serves as an imperfect seal when compressed against the top plate 105, which is typically formed of a hard material such as metal.

The configuration of the channel assembly 100 of FIG. 1 is prone to slow leaks that are responsible for variability in run-to-run and assembly-to-assembly performance. The membrane 112 is formed of porous spongy materials, so it seals to the spacer 210. When the assembly is firmly clamped together, the spacer 110 applies a force that partially crushes the membrane 112 beneath it which collapses the porous material of the membrane 112 and prevents a lateral flow of sample in the channel 130 that may otherwise cause mass loss or other undesirable effects.

During fractionation, some of the sample can get trapped in the corners of the rectangular channel. Even if it is not permanently stuck, it will elute later than predicted by theory, which ignores edge effects caused by the sample trapped in the dead volume around the o-ring 105. Since the seal formed by the membrane 112 and spacer 110 relies on the crushed membrane 112, no sample can leak laterally between the spacer 110 and the membrane 112 however because the spacer is made of a hard material, it is common for some of the sample to leak between the spacer 110 and the top plate 104, resulting in mass loss.

These membranes 112 must be replaced periodically due to their finite useable lifetimes. The channel assembly is opened, the components are cleaned, and it is reassembled. Care must be taken to avoid over-clamping the assembly to ensure that the top and bottom surfaces of the channel remain flat and parallel. Over-compressing the channel assembly may also damage it. Fragile membranes 112 can tear and the frit 114 can permanently deform or crack. Therefore, one must use a torque wrench and slowly tighten the clamping screws in a star pattern to ensure a uniform seal. A well-trained user can assemble the channel assembly reliably. For novice users, improperly torquing the channel assembly is a common failure mode. Often the buffer used as the mobile phase can leave salt residue in the threads of the bottom plate or base 120. If care is not taken to completely remove this salt residue and carefully lubricate the threads, then when the channel assembly is reassembled with a uniform torque applied to each bolt, varying friction from salt residue causes non-uniform clamping pressure. This causes the top and bottom of the channel volume to not be parallel, resulting in changes in the quality of the seal between 110 and 104 and intermittent performance issues.

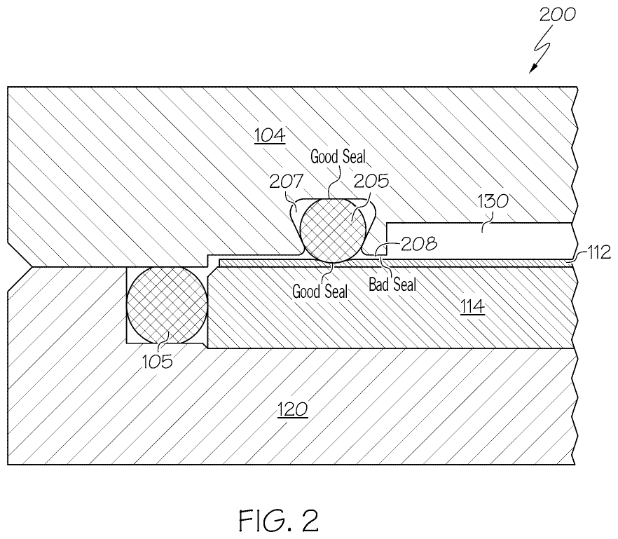

Another type of channel assembly is a fixed height (FH) assembly 200 shown in FIG. 2, which eliminates the spacer 110 shown in FIGS. 1A and 1B by machining the channel 130 into the top plate 104. An upper o-ring 205 is positioned in a recessed cavity or groove 207 (while the lower o-ring 105 in the bottom plate 120 is retained) to create a tighter seal. This solves the problem with leaks above the spacer, but it introduces a new mechanism for mass loss. A small dead volume exists in the o-ring groove 207, wherein sample may be trapped about the upper o-ring 205. Sample can also be trapped in region 208, which is part of the wall that retains the o-ring 205.

In brief overview, embodiments of the present inventive concept include a construction of an AF4 channel assembly that retains the benefits of a fixed height channel assembly, while resolving the potential for mass loss along the edges of the channel by preventing the loss of sample at the o-ring 205. This construction can address and overcome the limitations described above, namely, the poor mass recovery caused by leaks against the top plate of the channel assembly 100 in FIGS. 1A and 1B, and the trapping of sample material at the fixed height channel 200 of FIG. 2.

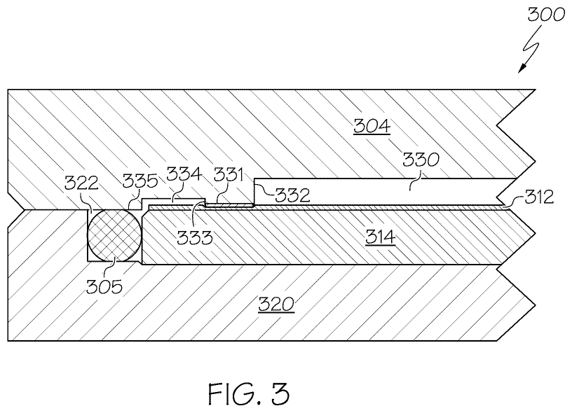

FIG. 3 is a cross-sectional view of an AF4 channel assembly 300, in accordance with preferred embodiments of the present inventive concept. As shown, the channel assembly 300 may include a top plate 304, a bottom plate 320, and a channel 330 in the top plate 304 and the bottom plate 320. An end of the channel 330 has a sidewall 332 of the top plate 304. More specifically, the bottom surface of the top plate 304 has a solid lip 331 that extends vertically from the top plate to compress the membrane 312. The lip 331 is unitary with the top plate 304 and therefore formed of the same material, e.g., a metal, alloy, etc. One end of the lip 331 is a distal end of the sidewall 332. In some embodiments, a sidewall 333 at the other end of the lip 331 forms one end of a gap 334 between the membrane 312 and the top plate 304. The gap 334 is optional. Therefore, in other embodiments, no gap 334 is present. This raised machined feature on the top plate 304 forms the lip 331 which in turn provides the fluid-tight seal between the lip 331 and the membrane 312, and further provides a fluid-tight seal between the gap 334 and the channel 330. A typical membrane used in field flow fractionation applications may be compressed by 50%, and so fluid flow is restricted from leaking towards the outer o-ring groove Instead, the seal is formed by relying on the lip 331 to compress the membrane 312 on the frit 314. The amount of deformable material in the channel is minimized, so there is little change in channel volume when the channel pressure varies. There is also no elastomer to extrude into the channel; the outer edge of the channel is defined by a clean machined feature. It is also simpler to manufacture with tight tolerances. Region 334 is included so that the seal of 331 can be of uniform with around the channel, but region 334 can be eliminated if desired to simplify construction of 304,

An o-ring 305 can be adjacent the channel 330 between the top plate 304 and the bottom plate 320. The bottom plate 320 may have a groove 322 that holds the o-ring 305 so that the o-ring 305 is sandwiched between the top plate 304 and the bottom plate 320, and directly abuts the frit 314. In other embodiments, the o-ring groove 322 can be constructed to entirely receive the o-ring 305 and capture it in a face seal so that the o-ring 305 does not contact the frit 314, which may include a larger o-ring and extension of the groove 322. The two seals serve different purposes. The o-ring 305 prevents fluid from leaking into the room. The solid lip 331 part of the top plate 304 seals the sample within the interior of channel 330, by at least partially compressing the membrane 312 (e.g., 50% compression but not limited thereto). Since the solvent can pass freely through membrane 312 into the frit 314, the entire region inside o-ring 305 is wetted, noting that some areas outside the channel are wetted, but not with the sample bearing fluid. In other words, the seal against the membrane 312 keeps the sample bearing fluid inside the channel although carrier fluid may pass through the membrane 312 and the frit 314.

Accordingly, the top plate 304 may have different widths or thicknesses to function as a seal with the membrane 312. The various widths are determined from the flat surface of the top plate 304 serving as a reference. Although reference is made to a “top surface” of the top plate 304, this is due to the illustration in FIG. 3. The “top surface” of the top plate 304 may be inverted to be a “bottom surface” for example when machining the top plate 304 according to the configuration shown in FIG. 3. A first width extends from the top surface of the top plate 304 to the bottom plate 320, a second width of the top plate 304 extends from the top surface and the gap 334. A third width extends between the top surface and the bottom of the lip 331. A fourth width extends from the top surface to the channel 330. As shown, a portion of the third width forming the lip 331 provides a sidewall of the channel 330. The critical distance for the crush seal against the membrane is a fifth width of the lip 331 relative to the datem plane where the top plate 304 and bottom plate 320 meet. This fifth width may be a difference between the first width and the third width.

More specifically, the fifth width is a critical dimension for the apparatus 300. A linear region of intersection between the top plate 304 and the bottom plate 320 form a datum plane that extends in a longitudinal direction. The bottom plate 320 is constructed so that the top of the frit 314 and the bottom of the membrane 312 are coplanar with the datem plane. The fifth width is the width from the distalmost end of the lip 331 to the datum plane. The fifth width defines a crush distance for the portion of the membrane sandwiched between the lip 331 and the frit 314. The fifth width defines the final crush distance of the membrane 312. For example, in some embodiments the membrane has a thickness of 150 um and the fifth width is 75 um, which gives a 50% compression.

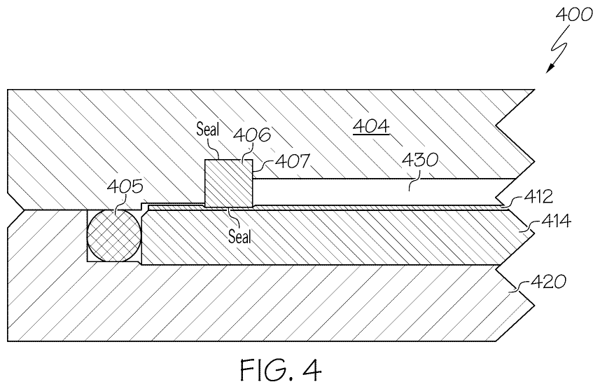

FIG. 4 is a cross-sectional view of an AF4 channel assembly 400, in accordance with other embodiments. As shown, the channel assembly 400 may include a top plate 404, a spacer 410, a membrane 412, a frit 414, a bottom o-ring 405, and a bottom plate 420, which form a channel 430. These components may be the same as or similar as those counterpart components of the channel assembly 300 of FIG. 3 and are not repeated for brevity. Like the AF4 channel assembly 300, the AF4 channel assembly 400 of FIG. 4 is constructed to retain the benefits of a fixed height channel assembly, i.e., more reliable sealing, easier and faster assembly, while resolving the potential for mass loss along the edges of the channel 130. In doing so, the channel assembly 400 incorporates features a fixed height assembly by implementing a square, rectangular, polygonal, or other multi-sided gasket 406 instead of an o-ring such as o-ring 205 in FIG. 2. This gasket 406 in FIG. 4 may comprises an elastomer such as ffkm (kalrez, markez, chemrez), nitrile rubber (buna-n), fkm (viton), and/or silicone rubber, but not limited thereto. The top plate 404 of the channel assembly 400 has a rectangular seat 407, or gland, cavity, indentation, groove, or the like for seating the gasket 406. In some embodiments, the gasket groove 407 comprises an inner wall corresponding to an inner gland of the top plate 404 and an outer wall corresponding to an outer gland of the top plate 404. In some embodiments, the height of the inner wall is less than the height of the outer wall. This approach prevents unwanted sample trapping by eliminating the extra dead volume around the multi-sided sealing element, or more specifically, the gasket 406 seated in the narrow seat 407 that has a comparable configuration as the gasket 406, multi-sided seat. For example, the seat 407 may be a cavity formed by first and second sidewalls extending 90 degrees from a top surface and the square or rectangular gasket 406 constructed and arranged for positioning in the seat 407, the gasket 406 having a width that is the same as or similar to a width of the top surface and having a height greater than a height of the first and second sidewalls for positioning as a line-to-line fit in the seat 407, i.e., the width of gasket ˜ same width of groove so that during pressurization, the gasket 406 is forced against the outer walls of the seat 407. In some embodiments, the gasket 406 is rectangular, i.e., taller than it is wide and have an associated rectangular gland 407 to accommodate it. The line-to-line fit provides enough friction to retain the gasket when the top plate is inverted during assembly. This arrangement, namely, the mating of the square or rectangular gasket 406 positioned in the square or rectangular groove 407 having a similar width resolves the potential for mass loss along the edges of the channel 430.

To ensure a seal against the membrane, the gasket is compressed vertically. Typically, a line-to-line fit cannot be used for gasket 406 because when compressed vertically it expands horizontally. The ratio of the compression to expansion is characterized by the well-known Poisson ratio. When designing a captured gasket 406 the usual guidance is room must be left for this expansion. Design guides recommend the gland to be at roughly 1.5× wider than the captured seal, but that is tantamount to leaving dead volume that can trap sample and give rise to a mass loss. The unique feature of the new design is that one can use a line-to-line fit by exploiting the fact that a FFF channel assembly does not need to completely encapsulate the gasket 406 like a standard face seal would. In the new design, the expansion implied by the Poisson ratio is accommodated by gently densifying the spongy membrane material beneath it, and by expanding into the interior of the channel 430. In particular, when the channel assembly 400 is assembled, the compression of the gasket 406 is directed into the channel 430 to prevent it from being over constrained.

As described above, there are several mechanisms that can result in mass loss. For example, sample can be retained in the corners of a rectangular channel, or dead volume, in which an o-ring is seated. In other cases, sample can leak from the channel due to an imperfect spacer seal. However, all of these mechanisms may only operate if the sample contacts the extreme edges of the channel. For many experiments, sample fractionation occurs near the center of the channel and very little sample contacts the sides. In these experiments, mass loss is not observed.

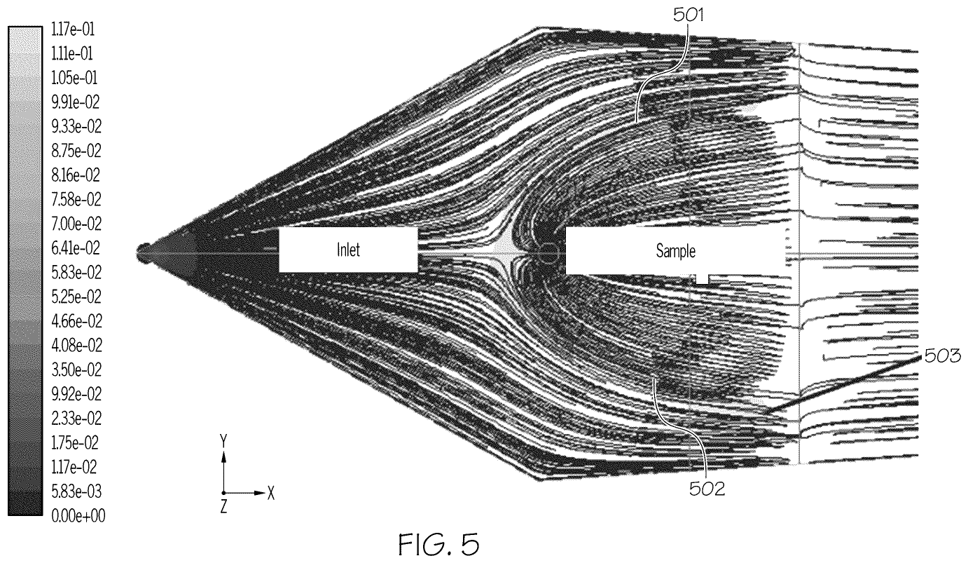

A technique that may be performed is to inject a sample into the channel and then focus it into a line. During the focus-elution step, fluid is injected from the inlet port on the left of the channel and sample is injected through a separate port. As can be seen in the CFD simulation in FIG. 5, while the sample is being injected a shock appears between the two flows 501, 502. Depending on their relative magnitudes, this shock shields the sample from the side walls of the channel at region 503 where mass loss may occur.

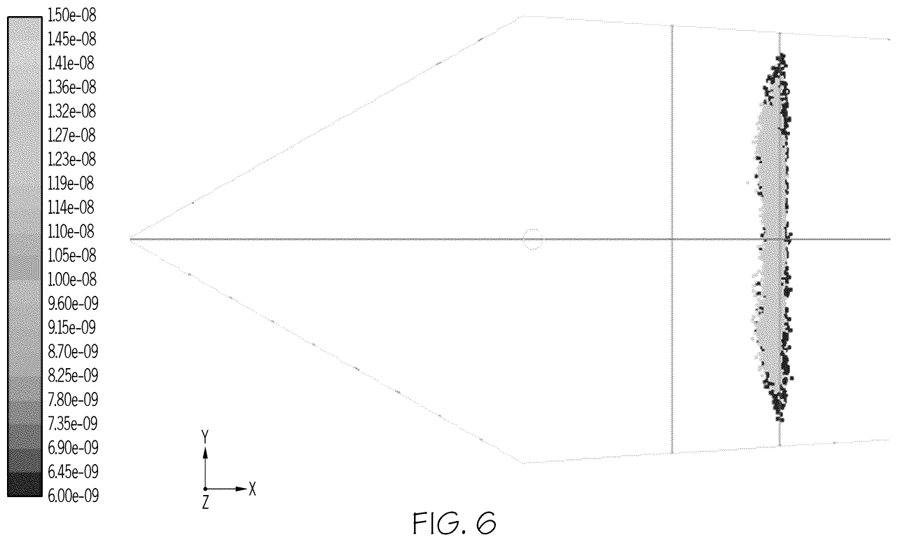

During the subsequent focus step, the extended sample region in FIG. 6 focuses into a line that does not contact the side walls as shown in the CFD simulation in FIG. 5. The shock boundary that separated the sample from the side walls persists after the focus step as a gap between the sample and the wall. The system can then be switched into an elution step and the fractionation process can begin. For these method parameters, little if any, sample would be lost by getting trapped in o-ring groove or corners.

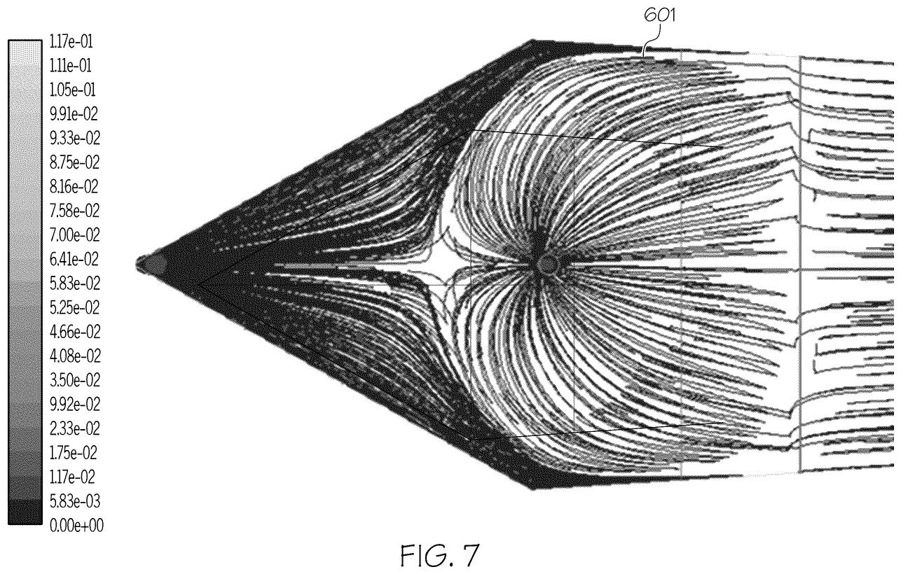

For other method parameters, such as a low ratio of inlet to inject flow, the shock boundary will be near the side walls, shown by arrow 601, and the protection it affords will be reduced, as illustrated in FIG. 7. One is usually not free to change the magnitude of the inlet flow, since when one specifies a given focus position and cross flow, the inlet flow is fixed. However, the injection flow is typically not a critical parameter. It has long been known that mass recovery improves when one uses a low injection flow rate relative to the inlet flow, and the description herein explains why.

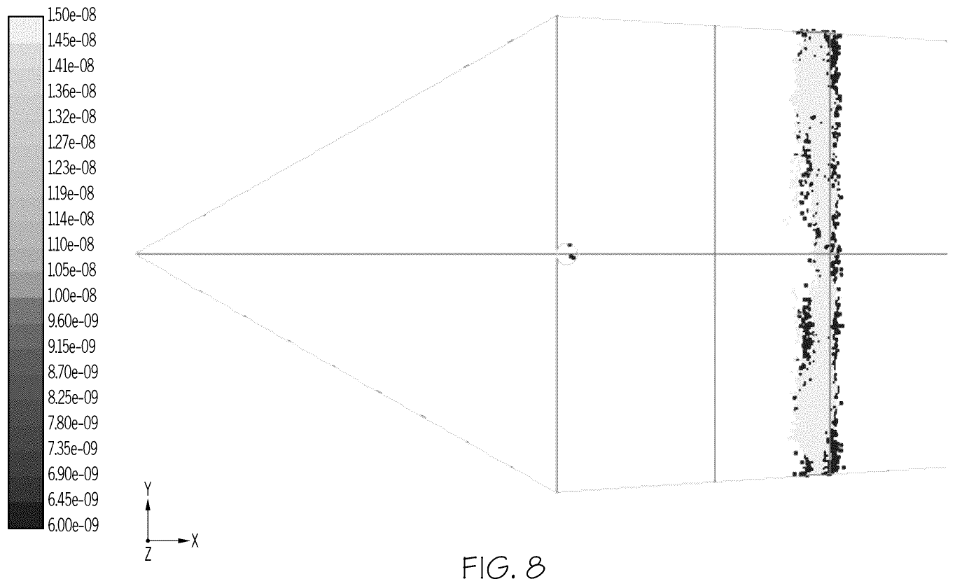

The subsequent focusing step for the nonideal injection produces a sample line that reaches the edge of the channel as shown in FIG. 8, or more specifically, a CFD Simulation of a nonideal sample injection after a focus step. As shown in FIG. 8, the sample is “focused” to a line that reaches the edge of the channel.

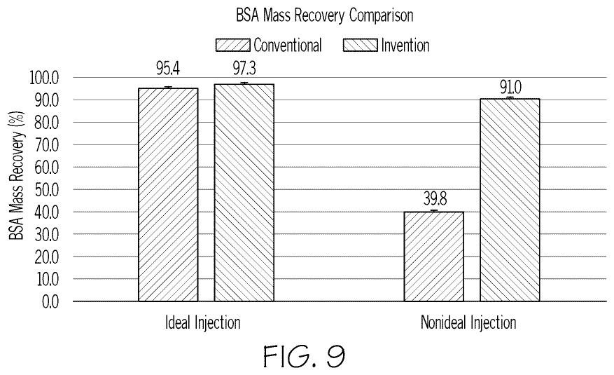

Nonideal injection results in low observed mass recovery for the previous fixed-height channel assembly design when using a method like that shown in FIGS. 7-8 that does not protect the sample from interacting with the edges. This is remedied by the new channel assembly design, e.g., shown in FIG. 3 or 4, which has good mass recovery for all methods, as shown in FIG. 9. In this diagram, an ideal injection has an inlet/inject flow ratio of 2.75. Using this ratio the sample never reaches the edges of the channel, and we see no significant difference in mass recovery between the two designs. The nonideal injection has an inlet/inject flow ratio of 0.25. Here the sample does reach the edge of the channel and we observe a large difference in mass recovery when comparing each design. Additionally, for the nonideal injection, if the duration of the focus step is increased, we observe increased mass loss compared to shorter duration focus steps. For FIG. 9, the nonideal injection featured a longer duration focus time to illustrate the performance improvements of the new design in the absolute worst-case scenario, the combination of low inlet/inject flow ratio as well as longer focus duration (allows more time for sample to spend near the edge).

The sealing detail on the edge of a FFF channel assembly affects the sample recovery. Some experimental methods show nearly perfect mass recovery because they prevent the sample from focusing near the well. Other methods show mass loss which indicates that edge effects, which are usually ignored, can become significant. Disclosed in some embodiments is a sealing mechanism and method that minimize edge effects and prevents sample from leaking from the separation channel. This retains the sealing gasket, which simplifies assembly.

The descriptions of the various embodiments of the present disclosure have been presented for purposes of illustration but not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A field flow fractionator comprising:
a top plate;
a bottom plate;
a channel between the top plate and the bottom plate;
an o-ring between the top plate and the bottom plate to form a first seal for the channel; and
a membrane along a bottom of the channel, wherein the top plate further comprises a lip extending vertically from the top plate to form a second seal for the channel by directly abutting the membrane.

2. The field flow fractionator of claim 1, further comprising a frit between the bottom plate and the membrane, wherein the lip compresses the membrane against the frit to form the second seal.

3. The field flow fractionator of claim 2, wherein the bottom plate has a cavity formed by machining the bottom plate for housing the o-ring, and wherein the o-ring is enclosed in the cavity by the top plate and the frit.

4. The field flow fractionator of claim 1, wherein the top plate has as a flat portion that directly abuts the bottom plate and compresses the o-ring and a gap between the flat portion and the lip.

5. The field flow fractionator of claim 1, wherein the channel is formed by machining the top plate, wherein an outer edge of the channel is defined by a clean machined feature of the lip.

6. The field flow fractionator of claim 1, wherein the lip is integral with and formed of a same material as the top plate.

7. The field flow fractionator of claim 1, wherein the lip forms a seal against the membrane to preserve sample bearing fluid in the channel.

8. The field flow fractionator of claim 1, wherein a linear region of intersection between the top plate and the bottom plate form a datum plane that extends in a longitudinal direction, wherein the field flow fractionator has a width from the lip to the datum plane, wherein the width defines a crush distance for the membrane at the width.

9. A field flow fractionator comprising:
a top plate assembly formed of a material comprising a plurality of fluid fittings machined into the material;
a membrane;
a bottom plate assembly comprising:
a cavity machined into a top surface of the bottom plate assembly;
a frit configured to be placed into the cavity, wherein the top plate assembly, the membrane, and the bottom assembly define a separation channel; and
an o-ring between the top plate assembly and the bottom plate assembly to form a first seal for the separation channel, wherein the top plate assembly further comprises a lip extending vertically from the top plate assembly to form a second seal for the channel by directly abutting the membrane.

10. The field flow fractionator of claim 9, wherein the lip compresses the membrane against the frit to form the second seal.

11. The field flow fractionator of claim 10, wherein the bottom plate has a cavity formed by machining the bottom plate assembly for housing the o-ring, and wherein the o-ring is enclosed in the cavity by the top plate assembly and the frit.

12. The field flow fractionator of claim 9, wherein the top plate assembly has as a flat portion that directly abuts the bottom plate assembly and compresses the o-ring and a gap between the flat portion and the lip.

13. The field flow fractionator of claim 9, wherein the channel is formed by machining the top plate assembly, wherein an outer edge of the channel is defined by a clean machined feature of the lip.

14. The field flow fractionator of claim 9, wherein the lip is integral with and formed of a same material as the top plate assembly.

15. The field flow fractionator of claim 9, wherein the channel is formed in the top plate assembly and the lip prevents sample bearing fluid from leaking from the channel.

16. The field flow fractionator of claim 9, wherein a linear region of intersection between the top plate assembly and the bottom plate assembly form a datum plane that extends in a longitudinal direction, wherein the field flow fractionator has a width from the lip to the datum plane, wherein the width defines a crush distance for the membrane at the width.

17. A field flow fractionator comprising:
a top plate comprising a cavity formed by first and second sidewalls extending 90 degrees from a top surface;
a square or rectangular gasket constructed and arranged for positioning in the cavity, the gasket having a width that is the same as or similar to a width of the top surface and having a height greater than a height of the first and second sidewalls to be placed in the cavity for a line-to-line fit, wherein the width of the gasket and a width of cavity are the same, and wherein as pressurized, the gasket is forced against the first and second sidewalls;
a membrane directly abutting a bottom surface of the gasket;
a channel having an end at a side surface of the gasket; and
a bottom plate that directly abuts the top plate to compress the gasket to form a first seal between the gasket and the cavity of the top plate and a second seal between the bottom surface of the gasket and the membrane.

18. The field flow fractionator of claim 17, wherein the cavity comprises
an inner wall corresponding to an inner gland of the top plate,
an outer wall corresponding to an outer gland of the top plate, and
wherein a height of the inner wall is less than the height of an outer wall.

19. The field flow fractionator of claim 17, wherein the top plate, the gasket, and the membrane form a channel of the field flow fractionator and are to act together to prevent lateral flow of sample out of the channel and retain sample within the channel.

20. The field flow fractionator of claim 17, wherein the first sidewall and the second sidewall have different heights.
